(19) United States
(12) Patent Application Publication
(10) Pub. No.: US 2003/0103237 A1
(43) Pub. Date: Jun. 5, 2003

(54) DEVICE AND METHOD FOR PRINTING PRESENTATION DOCUMENT

(76) Inventor: HO-SUNG HAN, KYONGGI-DO (KR)

Correspondence Address: ROBERT E BUSHNELL, ATTORNEY AT LAW, SUITE 330, 1522 K STREET NW, WASHINGTON, DC, 200051202

(21) Appl. No.: 09/320,715

(22) Filed: May 27, 1999

(30) Foreign Application Priority Data
May 27, 1998 (KR) 19222/1998

(51) Int. Cl. G06K 1/00; G06F 15/00

(52) U.S. Cl. 358/1.18; 358/498

(57) ABSTRACT

A device for printing a presentation document comprises a printing unit for printing data received from a computer, a print medium register unit which set up a print medium for printing the data, a print feeding unit which feeds the predetermined print medium to the printing unit, and a control unit which generates a control signal so as to output the data to the printing unit after reading the print medium type determined at the print medium register unit and selecting the corresponding print medium at the print feeding unit.

### CLAIM OF PRIORITY

This application makes reference to, incorporates the same herein, and claims all benefits accruing under 35 U.S.C. §119 from my application DEVICE AND METHOD FOR PRINTING PRESENTATION DOCUMENT filed with the Korean Industrial Property Office on May 27, 1998 and there duly assigned Serial No. 19222/1998.

### BACKGROUND OF THE INVENTION

1. Technical Field

The present invention is related to a printer and, more particularly, to a device and method for printing a presentation document on both transparency film and normal paper according to a mode of a printing medium selected by a user.

2. Related Art

Generally, a printer is the most common means for inspecting and storing computed results from a computer, and for printing the results in a document form to deliver to a third person. Thus, the printer has become a basic factor in such applications as multimedia, personal computer, facsimile, electronic cash register, automatic cash teller, etc. Currently, the daisy wheel type printer, pin type printer, inkjet type printer, and laser type printer have been developed, but the inkjet printer and laser printer are the most commonly distributed types.

Recently, along with fast developing office automation equipment, such as the scanner and facsimile, the demand for printers is increasing, and such office automation equipment is being developed with high technology in order to expand its own functions.

In addition, office automation equipment has been developed in combined types to replace devices which were used independently, and this spares users an economic burden and space requirements. Thus, there is a trend toward manufacture and sale of products with multi-document printing functions.

The present description describes a laser printer as an example selected from many printers. The laser printer controls printing of character fonts by laser. A controlled and processed beam is generated in a laser generator, and the beam is sent to a mirror at an opposite site.

Since the mirror is rotating at a very fast speed, the reflecting angle varies according to the beam generating time, and a reflected laser beam having different reflection angles is exposed to a drum in the printer.

Since the drum has a characteristic of changing its surface when exposed to light, it is divided into exposed and unexposed parts. When a powder type coloring matter called toner is stained on the drum, the exposed parts and unexposed parts are clearly distinguished, and if a paper is supplied and pressed in printing fashion, the desired character or figure is obtained.

Since the toner is not inclined to attach onto paper in a normal environment, a high temperature is applied in order to attach it to the paper and the paper is then exposed to an outer environment so as to produce a printed paper.

The laser printer can change the font of a character, can also print a picture similar to that of an inkjet printer, and has very excellent speed and resolution.

Currently an overhead projector (OHP) is a device used generally for making a presentation. While making the presentation using the OHP, generally, one copy of the presentation material is printed on a transparency film and several copies are either photocopied or printed on normal paper for provision to those attending the presentation. That is, in order to prepare the documents for the presentation, one transparency film and the same number of normal paper copies are printed for the presentation attendee. Thus, the conventional printing method as described above, has the inconvenience of requiring performance of the printing job twice to obtain the same results. Also, in order to get the same results, the same data has to be transferred to the printer twice, thereby having the disadvantage of consuming excessive printing time.

### SUMMARY OF THE INVENTION

The present invention is created to solve the problems described above. The purpose of the present invention is to provide users with a printer and its data printing method for printing as many is copies as desired of presentation data on both transparency films and normal paper with one printing command.

To achieve the above object and other advantages, there is provided a presentation document printing device with printing unit to print the data received from a computer, the device including: a print medium register unit that sets up the printer to print the data; a print feeding unit that feeds predetermined print to the printing unit; and a control unit which reads predetermined print type set-up data from the print medium register unit, which selects print at the print feeding unit, and which initiates a control signal to print the data at the above printing unit.

Preferably, the print device prints the data using either normal paper for general purpose use or a transparency film for presentation purposes. Accordingly, the print medium register unit uses the computer printing driver to setup the print medium. In addition, the print medium register unit uses a panel unit of the print device to setup the print device.

To achieve the above object, there is provided, in the present invention, a presentation document printing method including: a decision stage to determine whether the data is to be printed; a setting stage to set up the print device to print the data when printing data is called for; and a printing stage to print the data using a predetermined print device to print the data.

Preferably, the print device prints the data using either normal paper for general purpose use or a transparency film for presentation purposes. Selectively, the print device further comprises a step to determine the number of print copies on which to print the data.

### BRIEF DESCRIPTION OF THE DRAWINGS

A more complete appreciation of the invention, and may of the attendant advantages, thereof, will be readily apparent as the same becomes better understood by reference to the following detailed description when considered in conjunction with the accompanying drawings in which like reference symbols indicate the same or similar components, wherein:

FIG. 1 is a perspective view showing a general connection between a computer and a printer to print data;

FIG. 2 is a block diagram of a data printing process with the computer and the printer connected thereto;

FIG. 3 is a block diagram of a structure of a data printing device using a printer driver to select printing methods according to the present invention;

FIG. 4 is an illustrative diagram of a data printing example using the printer driver to select printing methods according to the present invention;

FIGS. 5A, 5B and 5C are illustrative diagrams of data printing examples using a panel unit to select printing methods according to the present invention; and

FIG. 6 is a flow chart showing data printing flow by selecting the printing methods according to the present invention.

### DETAILED DESCRIPTION OF THE PREFERRED EMBODIMENTS

The objectives, characteristics and advantages of the present invention will be described more fully in details hereafter with reference to the accompanying drawings, in which preferred embodiments of the invention are shown.

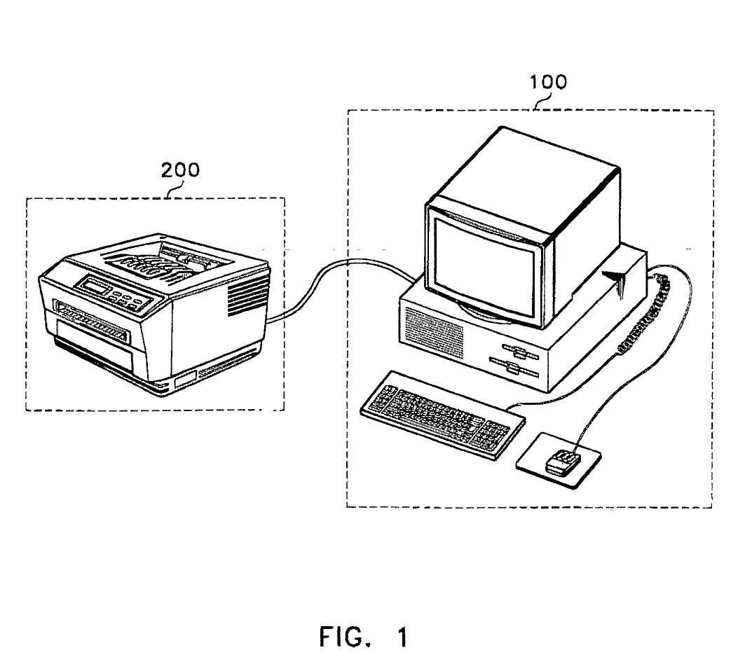

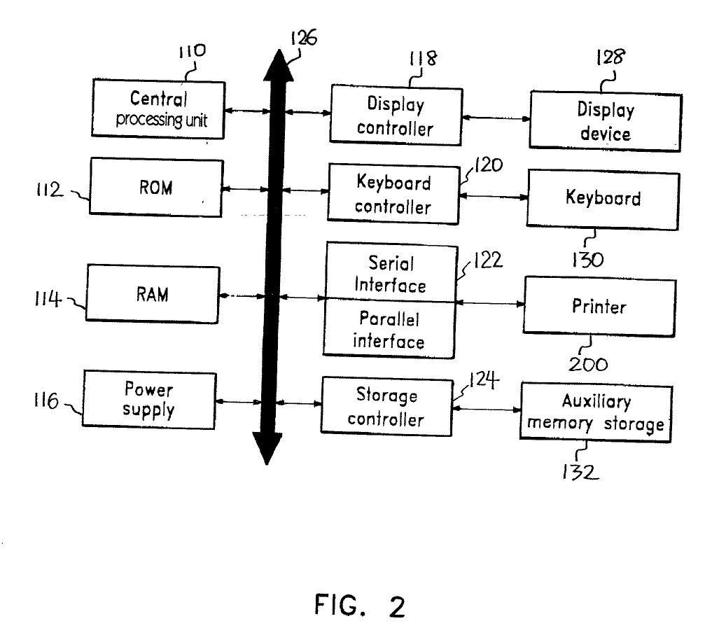

FIG. 1 is a perspective view showing a general connection between a computer and a printer to print data; and FIG. 2 is a block diagram of a data printing process with the computer and the printer connected thereto. As seen in FIG. 1, a general computer system comprises a computer 100 connected to a printer system 200. As seen in FIG. 2, the computer system includes a central processing unit (CPU) 110, a read only memory (ROM) or program memory 112, a random access memory (RAM) 114, a power supply 116, a display controller 118, a keyboard controller 120, a serial/parallel interface 122 and a storage controller 124, all interconnected by an input/output bus 126. The system further includes a display device 128 connected to display controller 118, a keyboard 130 connected to keyboard controller 120, printer 200 connected to serial/parallel interface 122, and an auxiliary memory storage 132 connected to storage controller 124.

As shown in FIGS. 1 and 2, the printing operation in a general computer system is controlled by an input-output controller (not shown) in central processing unit (CPU) 110 which controls data flow on the input-output bus 116. In order to control input-output of data in the computer system, the CPU 110 receives an input-output control command from program memory 112 through the input-output bus 126 and, after the interpreting of an interface, sends a control signal to a printer controller (not shown) in interface 122, thereby accomplishing the printing operation in printer 200.

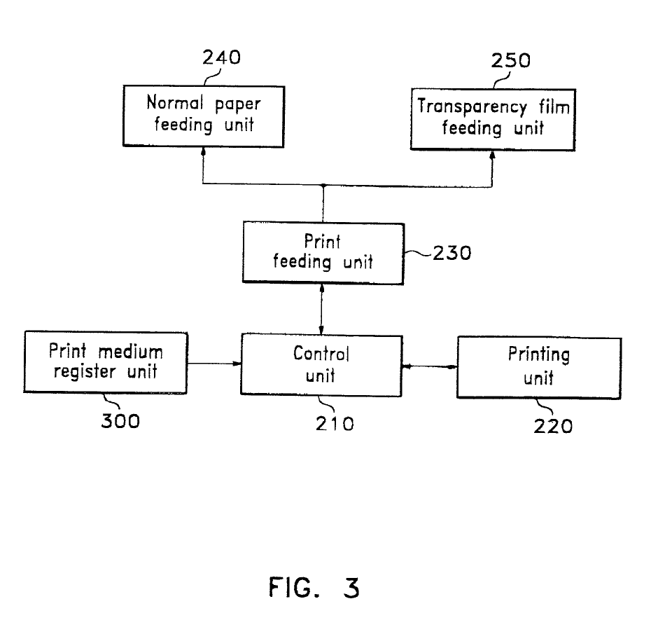

FIG. 3 is a block diagram showing a structure of a data printing device after using a printing driver to set up printing methods according to the present invention.

A print medium register unit 300 selects a print medium to print data developed in computer 100. A printing unit 220 prints the data transferred from the computer 100 with a predetermined format according to a print control signal from control unit 210. When the printing unit 220 prints data, a print feeding unit 230 feeds paper according to the format selected by the user.

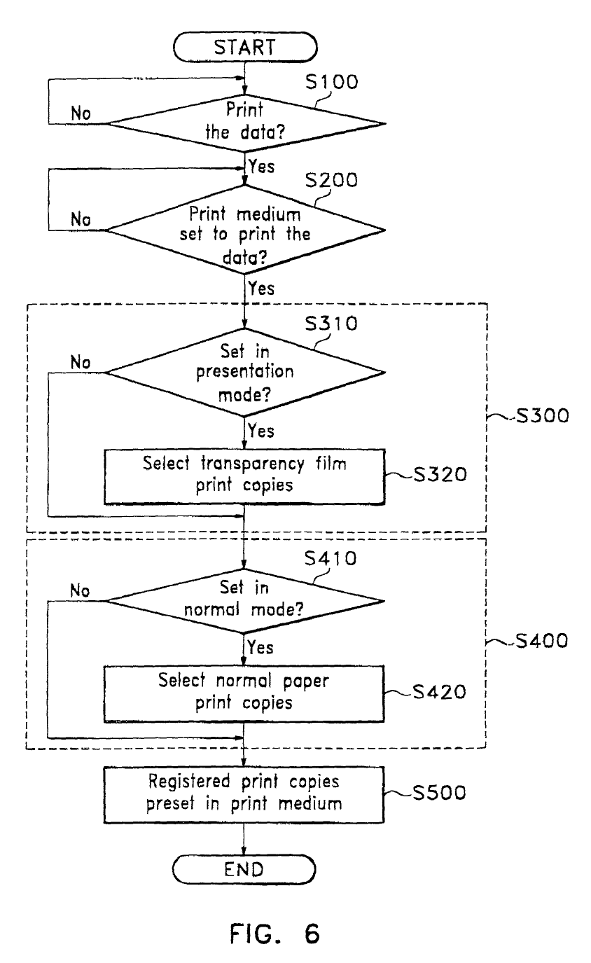

In addition, the print feeding unit 230 comprises two sections, a normal paper feeding unit 240 which feeds normal paper, and a transparency film feeding unit 250 which feeds transparency film, according to the present invention. In the thus-structured print device of the present invention, the operation of the device for printing a presentation document and a method of using the printing device will be described more fully hereinafter with reference to FIGS. 1 to 6.

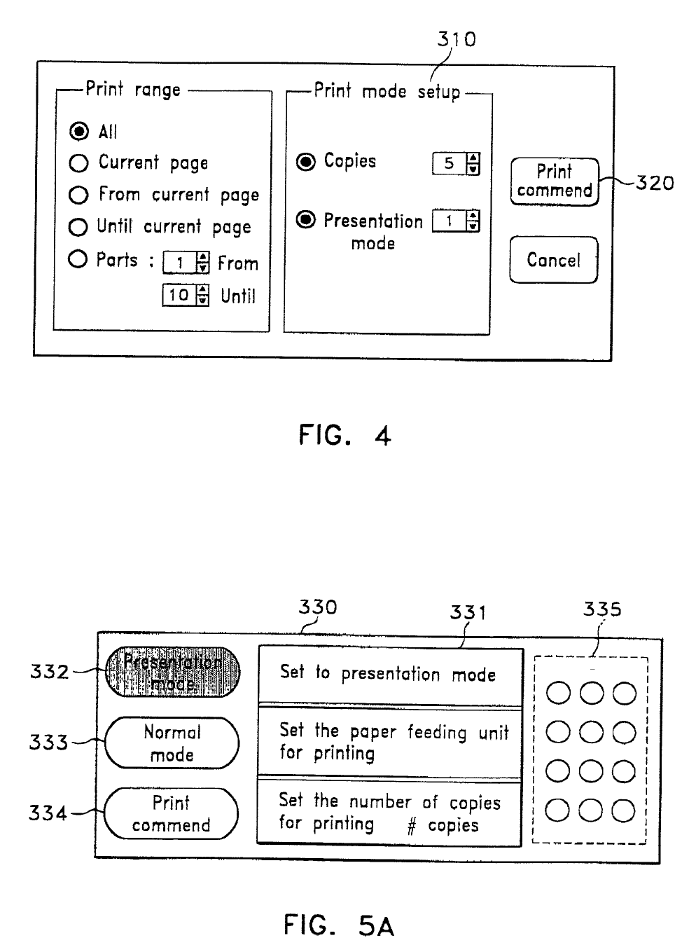

Firstly, the control unit 210 decides whether the data from the computer 100 should be printed at the printing unit 220 (Stage:S100). When printing the data, the control unit 210 decides whether the print medium is set up to print the data (Stage:S200). Additionally, the decision as to whether the print medium is set up can be made, as shown in FIG. 3, where the print medium register unit 300 performs accordingly, by a print mode register unit 310 which decides whether a normal mode or a presentation mode is selected to print the data as shown in FIG. 4.

When the printing device is set up, it is decided whether the data printing mode is selected to be the presentation mode (Stage:S310). The number of print copies is selected in the presentation mode (Stage:S320).

When the print medium is set up, it is decided whether the data printing mode is selected to be the normal mode (Stage:S410), and the number of print copies for the normal mode is selected (Stage:S420).

When a print commend 320 is input, as shown in FIG. 4, the control unit 210 receives information related to the predetermined number of print copies of the normal and presentation mode. Thus, as shown in FIG. 3, a normal feeding unit 240 and a transparency film feeding unit 250 connected to the print feeding unit 230 feed the predetermined number of print media, and accordingly the printing unit 220 prints the data (Stage:S500).

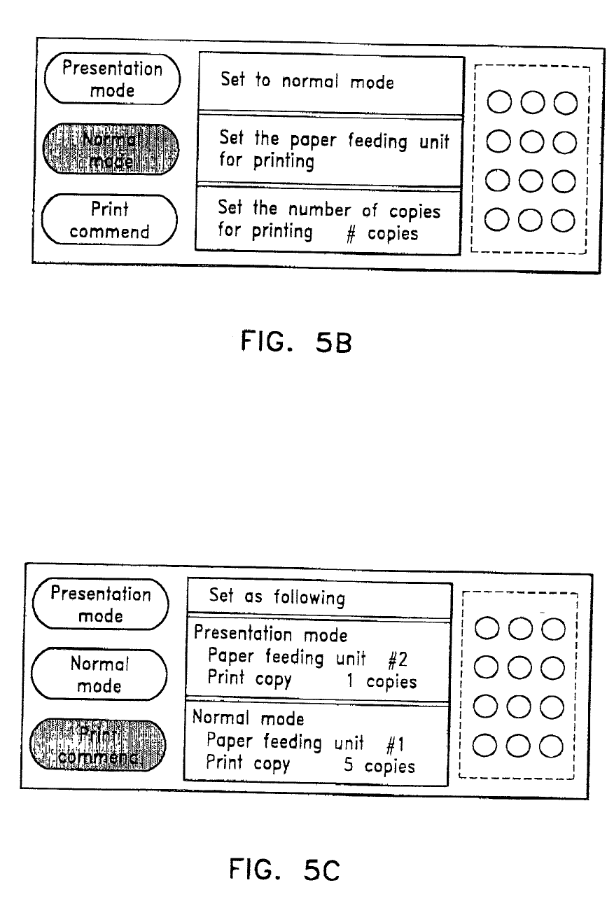

Another performance example of the present invention can be found using a panel unit 330 (FIG. 5A) of a laser printer 200 as the print medium register unit 300.

When printing data from the computer 100 with the laser printer 200, and when the presentation mode 332 is selected to print the data on transparency film as shown in FIG. 5A, a number generating unit 335 is used to set up the feeding unit 250 and the number of print copies of presentation mode data on an LED display device 331.

In a similar manner, when the normal mode 333 is selected to print the data on normal paper as shown in FIG. 5B, the number generating unit 335 is used to set up the paper feeding unit 240 and to print copies of normal mode data on the LED display device 331.

After setting the environment to print in the presentation mode or normal mode, when a print commend 334 is input, as shown in FIG. 5C, the predetermined environment is displayed on the LED display device 331 and the printing unit 220 of FIG. 3 prints the data.

With reference to the aforementioned, according to the present invention, when printing presentation materials on transparency film, it is possible to obtain the results more quickly and with simple operation by the user. Also, the possibility to print on normal paper simultaneously increases work efficiency, and thus promotes user convenience.

This invention has been described above with reference to the aforementioned embodiments. It is evident, however, that many alternative modifications and variations will be apparent to those having skill in the art in light of the foregoing description. Accordingly, the present invention embraces all such alternative modifications and variations as fall within the spirit and scope of the appended claims.

What is claimed is:

1. A device for printing a presentation document, comprising:
a printing unit for printing data received from a computer;
a print medium register unit which sets up a print medium for printing the data;
a print feeding unit which feeds the set up print medium to the printing unit; and
a control unit which generates a control signal so as to output the data to the printing unit after reading a print medium type from the print medium register unit and after selecting the set up print medium at the print feeding unit.

2. The device for printing a presentation document according to claim 1, wherein the print medium is one of a normal paper used to print the data for general use and a transparency film used to print the data for presentation purposes.

3. The device for printing a presentation document according to claim 1, wherein the print medium register unit registers the print medium using a print driver in the computer.

4. The device for printing a presentation document according to claim 1, wherein the print medium register unit registers the print medium using a panel unit of the printing unit.

5. A method for printing a presentation document, comprising the steps of:
determining whether data is to be printed;
registering a print medium for printing the data when the determining step determines that data is to be printer; and
printing the data using the registered print medium.

6. The method for printing a presentation document according to claim 5, wherein the print medium is one of a normal paper used to print the data for general use and a transparency film used to print the data for presentation purposes.

7. The method for printing a presentation document according to claim 5, further comprising the step, between the registering and printing steps, of registering a number of printing copies on which to print the data on said registered print medium.

8. The method for printing a presentation document according to claim 5, wherein said registering step comprises determining a print medium selected by a user.

9. The method for printing a presentation document according to claim 8, wherein said registering step further comprises determining whether the print medium selected by the suer is set to print the data.

10. The method for printing a presentation document according to claim 8, wherein the print medium is one of a normal paper used to print the data for general use and a transparency film used to print the data for presentation purposes.

11. A device for printing a presentation document, comprising:
printing means for printing data received from a computer;
print medium register means for setting up a print medium for printing the data;
print feeding means for feeding the set up print medium to the printing means; and
control means for generating a control signal so as to output the data to the printing means after reading a print medium type from the print medium register means and after selecting the set up print medium at the print feeding means.

12. The device for printing a presentation document according to claim 11, wherein the print medium is one of a normal paper used to print the data for general use and a transparency film used to print the data for presentation purposes.

13. The device for printing a presentation document according to claim 11, wherein the print medium register means registers the print medium using a print driver in the computer.

14. The device for printing a presentation document according to claim 11, further comprising a panel unit for use by a user in entering a selection for selecting the print medium, and wherein the print medium register means registers the print medium using the selection entered by the user at the panel unit.

15. The device for printing a presentation document according to claim 11, further comprising print mode register means for determining a printing mode selected by a user, said print medium register means being responsive to the determination by said print mode register means for setting up a print medium corresponding to the mode selected by the user.

16. The device for printing a presentation document according to claim 15, wherein the selected print medium is one of a normal paper used to print the data for general use and a transparency film used to print the data for presentation purposes.

17. A method for printing a presentation document, comprising the steps of:
determining whether data is to be printed;
determining whether a print medium is set to print the data when the data is to be printed;
determining whether a presentation mode is set;
selecting transparency film print copies when the presentation mode is set;
determining whether a normal mode is set where the presentation mode is not set;
selecting normal paper print copies when the normal mode is set;
registering a print medium corresponding to the print copies selected; and
printing the data using the registered print medium.

18. The method for printing a presentation document according to claim 17, further comprising the step of registering a number of printing copies on which to print the data in the registered print medium.
